(19) United States
(12) Patent Application Publication
(10) Pub. No.: US 2014/0156812 A1
(43) Pub. Date: Jun. 5, 2014

(54) CUSTOMIZED CONFIGURATION SETTINGS FOR A NETWORK APPLIANCE

(71) Applicant: FORTINET, INC., Sunnyvale, CA (US)

(72) Inventors: Xianfeng Deng, Coquitlam (CA); Ihab Khalil, Port Coquitlam (CA)

(73) Assignee: Fortinet, Inc., Sunnyvale, CA (US)

(21) Appl. No.: 13/705,601

(22) Filed: Dec. 5, 2012

(51) Int. Cl. G06F 15/177

(52) U.S. Cl. CPC G06F 15/177
USPC 709/220

(57) ABSTRACT

Methods and systems for temporarily configuring a network appliance in accordance with externally provided customized configuration settings are provided. According to one embodiment, a network appliance may operate in one of multiple configuration modes, including an internal configuration mode and an external configuration mode. When operating in the internal configuration mode, the network appliance loads and runs configuration settings from a memory internal to the network appliance. When operating in the external configuration mode, the network appliance loads and runs configuration settings from an external storage device coupled to an interface of the network appliance.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2012, Fortinet, Inc.

### BACKGROUND

1. Field

Embodiments of the present invention generally relate to the field of computer networks. In particular, various embodiments relate to methods and systems for temporarily configuring a network appliance in accordance with externally provided customized configuration settings to facilitate auditing, for example.

2. Description of the Related Art

Computer networks used by large business enterprises generally consist of a network of networks spread over geographical regions ranging from different buildings to different continents. Each individual network may contain various network appliances such as routers, switches, gateways, firewalls, Wireless Access Points, and can also be considered to include general purpose computing devices such as personal computers, PDA's, laptops, printers, among others. Network appliances typically provide ability to electronic devices to communicate and exchange content/information with other remote electronic devices that are spread over geographical regions.

While access to network appliances provides for exchange of data and traffic through multiple services, such services also serve as open doors to the network appliance for malicious access. While security measures such as SNMP community strings, firewalls, IDS (Intrusion Detection Systems), ACLs (Access Control Lists), and VPNs (Virtual Private Networks) try to prevent malicious use by hackers, level and threat of security in the network is not always known, especially as security configurations across various network appliances vary significantly. Consequently, maintaining the health of devices and network appliances present in network poses considerable challenges.

Challenges can pertain to keeping network availability option open, safe to use, robust, and maintain high reliability in complex networks having multiple routing/switching devices interconnected with each other. Often, it is difficult for end users and even network administrators/operators to analyze data and problems that exist in such complex networks. For instance, although a software running in a computer system may need to be regularly updated/installed based on existing network configuration, it becomes difficult for an end user to identify whether any malware or virus is also being simultaneously installed in the client machine during such an installation.

Increasing usage of the Internet and a proportional growth in the threat relating to data theft, undesired traffic flow, malicious attacks, among other allied issues to companies and end users makes it important to manage large and complex networks. Various tools have been developed and implemented for management of networks, wherein such tools have an ability to audit performance of the network infrastructure by monitoring and analyzing traffic flow, routing patterns, among other allied performance attributes. Network auditing is typically a part of information technology audit or information system audit that evaluates obtained evidence to determine whether systems connected to network are safeguarding information, maintaining data integrity, and operating effectively to achieve organization's goals or objectives.

Typically, a network auditor either directly or through a client computing device connects to a network appliance, such as an anti-spam appliance, a Unified Threat Management (UTM) appliance, a firewall, a modem, a router, a switch, a hub, and the like, and monitors data flow that takes place across the network appliance to evaluate whether data flowing through the network appliance is being safeguarded and provided with integrity or not. Network auditing helps in understanding the level of security provided to data flowing through the network appliance and to understand the kind of measures taken to improve data security and integrity for data flowing through the same. Existing methods used for conducting audits of network appliances include modifying configuration settings and parameters of the network appliances by replacing local configuration settings with customized configuration settings and then performing desired analysis. In such methods, once the network audit is complete, local settings are restored and overwritten in the memory of the network appliance. Making such changes, including overwriting and replacing configuration settings in the network appliance can lead to inefficiencies associated with reconfiguration, loss of data, change in routing/switching patterns, undesired changes in settings of the network appliance, and such other problems, which can result in faulty or unexpected behavior of the concerned network appliance.

In order to make the network audit process more reliable and efficient to conduct, there exists a need for methods and systems that can perform network audits of appliances without overwriting or replacing local configuration settings and maintain integrity of the network appliance.

### SUMMARY

Methods and systems are described for temporarily configuring a network appliance in accordance with externally provided customized configuration settings. According to one embodiment, a network appliance may operate in one of multiple configuration modes, including an internal configuration mode and an external configuration mode. When operating in the internal configuration mode, the network appliance loads and runs configuration settings from a memory internal to the network appliance. When operating in the external configuration mode, the network appliance loads and runs configuration settings from an external storage device coupled to an interface of the network appliance.

Other features of embodiments of the present disclosure will be apparent from accompanying drawings and from detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates exemplary network architecture in accordance with an embodiment of the present invention.

FIG. 2 illustrates exemplary functional units of a network appliance in accordance with an embodiment of the present invention.

FIG. 3 illustrates connection between a network appliance and an external storage device storing customized configuration settings in accordance with an embodiment of the present invention.

FIG. 4 illustrates exemplary internal components of an external storage device in accordance with an embodiment of the present invention.

FIG. 5 illustrates use of an external storage device for multiple network appliances in accordance with an embodiment of the present invention.

FIG. 6 illustrates a tabular representation of parameters used for defining internal and customized configuration settings in accordance with an embodiment of the present invention.

FIG. 7 is a flow diagram illustrating a method for temporarily configuring a network appliance in accordance with externally provided customized configuration settings in accordance with an embodiment of the present invention.

FIG. 8 is an exemplary computer system in which or with which embodiments of the present invention may be utilized.

### DETAILED DESCRIPTION

Embodiments of the present invention generally relate to methods and systems for temporarily configuring a network appliance in accordance with externally provided customized configuration settings to facilitate one or more functionalities, such as auditing, testing, verification and the like. As the customized configuration settings are provided temporarily through an external configuration mode, there is no overwriting of settings stored internally within the memory of the network appliance, and therefore no change is made to internal configuration settings, allowing efficient switching between internal and external configuration modes and settings configured thereby. Therefore, for preventing any loss of internal configuration settings of network appliance and data stored in RAM during configuration by changing configuration settings during execution of desired functionality, there is a need for methods and systems for temporarily configuring network appliance in accordance with externally provided customized configuration settings. There is also a need for methods and systems that can retrieve customized externally provided configuration settings from an external storage device and run external configuration settings only during auditing, and switch back to internal configuration settings of network appliance sooner external storage device that stores externally provided configuration settings is disconnected or decoupled from network appliance. There is also a need for methods and systems to provide easy and secure connection of external storage device to network appliance.

According to one embodiment, methods and systems are provided for loading and running externally provided customized configuration settings for conducting network audit to determine compliance of the network appliance with established routing and traffic policies, identify compliance with a set of expected standards for management and security of networks connected to backbone, monitor and provide an overall review of consistency, quality, and reliability of network management processes related to the network appliance, examine and analyze the volume, type, or quality of traffic flowing through the network appliance, among other such objectives. Audit of such network appliances may be performed so as to monitor their performance, efficiency, traffic flow pattern, security, compliance with established policies, and other attributes of interest. Methods of the present invention can also be used for multiple other purposes apart from auditing, including but not limited to, verification and testing among other such purposes.

According to one embodiment, the present disclosure describes a method and system that is configured to provide a network appliance with a plurality of configuration modes for running different configuration settings, wherein configuration modes include an internal configuration mode and an external configuration mode. The method further provides configuring network appliance by loading and running configuration settings from a memory internal to network appliance when the appliance is operated in internal configuration mode. In this internal mode, network appliance is configured by accessing internal configuration settings stored in memory internal to network appliance, loading accessed internal configuration settings into a processor of network appliance, and running accessed internal configuration settings.

In one embodiment, a method, as part of the external configuration mode, provides for configuring network appliance by loading and running configuration settings from an external storage device coupled to an interface of network appliance. The external configuration mode can include detecting external storage device and accessing external configuration settings stored in storage device to enable loading and configuration of the settings and running them on processor of network appliance. External storage device can include a USB, flash drive, external hard drive, among other such storage mediums.

The method further provides for configuring network appliance back to internal configuration mode when external storage device is decoupled or removed from network appliance. Once the network appliance detects that external storage device is no longer coupled with the appliance, internal configuration settings are automatically loaded back and restored to enable the appliance to be configured and run based on the internal settings.

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

Although the present disclosure has been described with the purpose of conducting network auditing, it should be appreciated that the same has been done merely to illustrate the invention in an exemplary manner and any other purpose or function for which the explained structure or configuration can be used, is covered within the scope of the present disclosure.

### Terminology

Brief definitions of terms used throughout this application are given below.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phrases do not necessarily refer to the same embodiment.

If the specification states a component or feature “may”, “can”, “could”, or “might” be included or have a characteristic, that particular component or feature is not required to be included or have the characteristic.

The phrase “network appliance” generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, Layer 2/3 routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

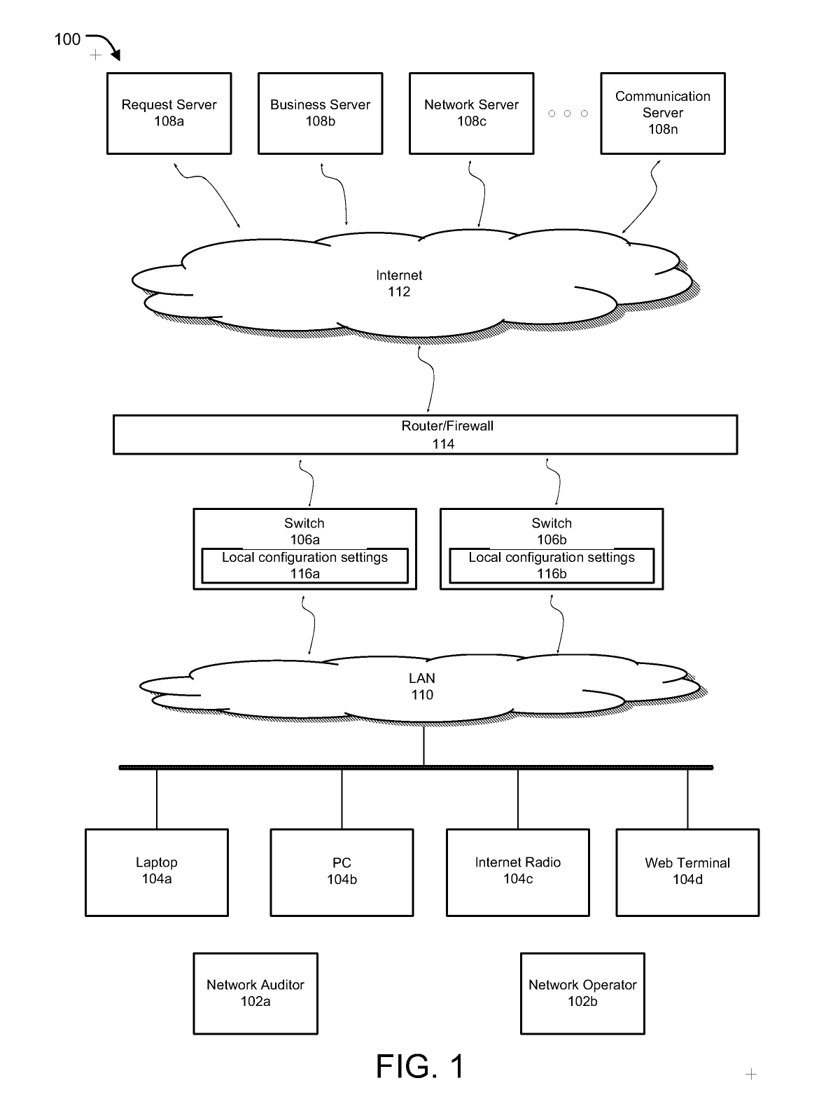

Embodiments of present disclosure and their advantages are best understood by reference to FIG. 1. FIG. 1 is an exemplary network architecture conceptually illustrating a system 100 having network appliances for performing various networking functions. In the context of the present example, system 100 includes one or more network auditors 102a for performing network auditing of network appliances and one or more network operators 102b who manage or administer the network of system 100. Network operator 102b can be configured to manage connections between computing devices such as laptop 104a, PC 104b, internet radio 104c, web terminal 104d, among other such devices 104 and servers such as request server 108a, business server 108b, network server 108c, and communication server 108n, among other such servers 108 that are configured to store content, information, or any desired data to be accessed by computing devices 104 through Internet 112.

Computing devices 104 access desired data through servers 108 that are operatively connected to the Internet 112 through one or more network resources. In one embodiment, computing devices 104 are connected via wired or wireless connections to a local area network (LAN) 110 to access Internet 112 through a common interface. LAN 110 may be connected to other networking devices, such as switches 106a-b, among other network devices, also referred to as network appliances 106 hereinafter, which help manage traffic flowing within LAN 110 and/or from LAN 110 to the Internet 112. System 100 may also include a router/firewall 114 that may operate as a network security or access control mechanism and which may be configured to shield data and resources from computer network intruders and create an electronic boundary that prevents unauthorized users from accessing files or other content on a network or a computing device. Router/firewall 114 may also include local configuration settings (not shown)

According to one embodiment, network appliances 106 not only include networking devices such as routers, switches, modems, load balancing devices, gateways, wireless access points, threat management systems, hubs, firewalls, or other such devices that allow network access control, network security control, among others functions, but can also include personal computers, printers, laptops, or other web enabled computing devices 104 that are configured to access internet 112 through such networking devices mentioned above. Therefore, the scope of network appliances 106 of the present disclosure includes computing devices 104 and network devices, such as switches 106a-b and router/firewall 114 among other networking devices. It would also be appreciated that the system 100, as illustrated in FIG. 1, is merely an exemplary illustration and any other configuration of network architecture can be incorporated to practice the present invention. For instance, instead of the switches 106b, traffic flow can be managed solely by routers or gateway devices. In some other embodiments, any other network appliance such as bridges, hubs, modems, and the like can be incorporated.

Network auditors 102a are configured to monitor, assess, and quantify performance of configurations, security settings, and access control mechanisms, among other aspects of network appliances 106. As network appliances 106 can include network security systems, network auditors 102a or other appropriate stakeholders can also use network audits as a mechanism of checking compliance of the network appliance 106 with established routing and traffic policies, identify compliance with a set of expected standards for management and information security of networks connected to backbone, monitor and provide an overall review of consistency, quality, and reliability of network management processes related to the network appliance, examine and analyze the volume, type, or quality of traffic flowing through the network appliance, among other such objectives.

According to one embodiment, network appliance 106 includes an internal memory that is configured to store local configuration settings 116a-b, collectively referred to as local configuration settings 116 hereinafter. Local configuration settings 116 can include system level configuration settings that are set manually by a network operator or set automatically as default by the system for performing tasks in an efficient manner. Local configuration settings 116 are used by the processor of respective network appliance 106 while processing functions of appliance 106 or processing data stored in or executed through the network appliance 106. Local configuration settings 116 include rules and commands that are executed by processor of network appliance 106 and can define set of permissions or access rights issued to users of data. When network appliance 106 is connected to Internet 112 and operating in accordance with an internal configuration mode, content is accessed and displayed to user based on local configuration settings of the network appliance 106. Local configuration settings 116 are also commonly referred to as internal configuration settings 116 as these configuration settings are present internal to network appliance 106 and stored in internal memory of the appliance 106.

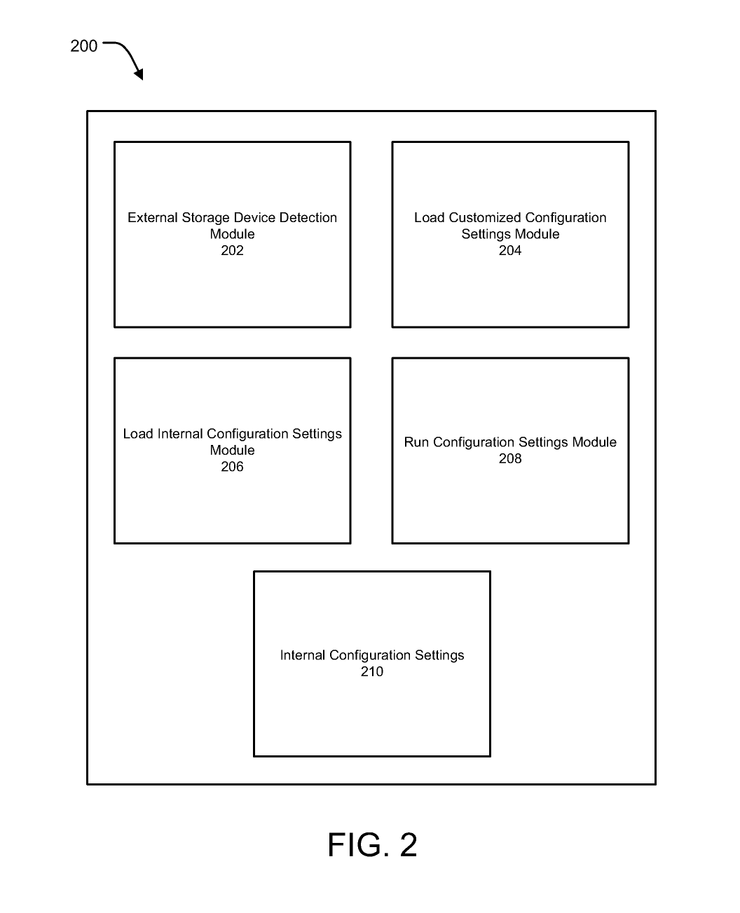

Each network appliance 106 includes one or more processors, a communication interface device, and one or more internal data storage devices that are operatively coupled with the processors. Processors can include a controller that processes content, information, and settings 116 stored in internal memory of the network appliance 106, based on which functioning of appliance 106 can be carried out by network operator 102b. Communication interface device, on the other hand, is a port on network appliance 106 to which a network auditor 102a can connect an external storage device (not shown) and access content stored in the external device for performing functions using the accessed external content. Various exemplary modules or structural features of network appliance 106 are described briefly in FIG. 2.

FIG. 2 illustrates exemplary functional modules and content stored and implemented through internal memory of network appliance 200. As structure and function of the processor(s) and communication interface device(s) of network appliance 200 are well known, they are not being illustrated in FIG. 2 of the present disclosure. Network appliance 200 may comprise of one or more processors that are operatively coupled with internal memory of appliance 200 to access functional modules and content stored in memory and execute instructions implemented in functional modules to generate desired results. As illustrated in FIG. 2, network appliance 200 includes an external storage device detection module 202, a load customized configuration settings module 204, a load internal configuration settings module 206, and a run configuration settings module 208. Internal memory, also interchangeably referred to as internal data storage device, of network appliance 200 also stores internal configuration settings 210.

Internal configuration settings 210 include local configuration settings present in internal memory of network appliance 200, wherein processor of network appliance 200 is configured to use these internal configuration settings 210 for using appliance 200 in a desired manner and mode. Internal configuration settings 210 can include one or more of valid traffic classes, a normal burst size, Weighted Fair Queuing (WFQ) bandwidth usage, a standby routing protocol, a router ID for Open Shortest Path First (OSPF) routing protocol, route reflector setup settings, Border Gateway Protocol (BGP) neighbour reachability information, a BGP synchronization setting, one or more multiprotocol label switching (MPLS) parameters, a log level, a community-string, an object qualifier, among other such configuration setting parameters. Internal configuration settings 210 can have default values associated thereto, which can be changed as and when desired and stored back in internal memory of network appliance 200. According to one embodiment, internal configuration settings 210 can be changed by a network administrator, operator, or any other appropriate person including a network auditor who conducts periodic monitoring of network appliance 200 to confirm its compliance with information security policies.

External storage device detection module 202, stored in internal memory of network appliance 200, can be executed by one or more processors of the appliance 200 and can be configured to indicate whether an external storage device is coupled to communication interface device of appliance 200. According to one embodiment, communication interface device can include any port of appliance 200 that can allow coupling with an external device such that if any external storage device is coupled to a communication interface device, the respective port number of the communication interface device is activated for initiating communication with external storage device and a notification is sent to external storage device detection module 202. External storage device can include any device such as Universal Serial Bus (USB) flash drive, a flash card, a Secure Digital (SD) card, an external hard drive, a floppy disk, compact disc (CD) or DVD, and the like that have a memory configured to store information and content across one or more formats.

External device can be configured to store customized configuration settings, which may or may not be same as internal configuration settings 210 of appliance 200. Customized configuration settings can be defined through parameters that relate to the function for which the setting are intended to be used. In one instance, the parameters can relate to audit parameters that, individually or collectively, audit one or more of security, reliability, loopholes, quality of data, quality of service, and quality of transmission of network appliance system. Similarly, other settings of appliance 200 can also be configured through customized configuration settings stored in external device. Such customized configuration settings can either include same parameters as the internal configuration settings 210 or can include more or less than the number of parameters stored in the internal configuration settings 210. For instance, customized configuration settings stored in external device may be configured to store only the important setting parameters such as route reflector setup parameters, Border Gateway Protocol (BGP) neighbor reachability parameters, and not all the local configuration settings stored in the internal memory of appliance 200. In one embodiment, the customized configuration settings are stored in the memory of external device in an encrypted format.

According to an embodiment, external storage device detection module 202 is configured such that if detection module 202 does not detect coupling of an external storage device, network appliance 200 is run based on internal configuration settings 210 by default. External storage device detection module 202 can either be executed at periodic and defined intervals or can be automatically run whenever an external device is coupled to network appliance 200 through a communication interface device to evaluate whether the external device is a storage device and stores customized configuration settings.

Load customized configuration module 204 is configured to be executed responsive to detection of external storage device by detection module 202 at one of the interfaces of appliance 200 such that sooner the external storage device is detected at appliance 200, load customized configuration module 204 is fetched by one or more processors of appliance 200 and executed. Load customized configuration module 204 accesses memory of external storage device in order to detect and fetch customized configuration settings present in external device. Once detected, the load customized configuration module 204 loads desired and required system configuration settings from the customized configuration settings and configures network appliance 200 based on customized configuration settings. Once customized configuration settings are loaded, network appliance 200 is run based on customized settings without replacing internal configuration settings stored in internal memory of appliance 200.

According to one embodiment, customized configuration settings stored in external storage device are encrypted using passwords or any other commonly known encryption methods to prevent data from hacking, virus attacks, and the like and to prevent customized settings from any other threats being posed during loading. Encryption of customized configuration settings also avoids automatic execution of customized configurations and thereby prevents loss of unsaved data of internal configuration settings 210 present in RAM of network appliance 200. Encrypted customized configuration settings are decrypted before running on the processor of appliance 200. In another embodiment, several internal configuration settings 210 can also be used along with customized configuration settings based on the need and for efficient running of network appliance 200. For instance, during a network audit operation, customized configuration settings loaded by load customized configuration settings module 204 can specifically relate to the audit process and may need certain general settings of the appliance, which can be fetched at runtime from internal settings stored in internal memory.

Load internal configuration settings module 206 is responsive to detecting absence of external storage device being coupled to appliance 200. Sooner appliance 200 detects that an appropriate external storage device having customized settings is not coupled with it, load internal configuration settings module 206 can be executed to load system configuration settings that form part of internal configuration settings stored in internal memory of appliance 200. As would be appreciated, load internal configuration settings module 206 can be executed sooner appliance 200 is initiated/started so that internal configuration settings are continuously used until module 202 detects presence of an external storage device.

According to one embodiment, once external storage device has been detected and external configuration settings are being used to configure and run network appliance 200 as a result of network appliance 200 being placed into an external configuration mode, for example, load internal configuration settings module 206 is executed upon decoupling of the external storage device. Before loading internal configuration settings, load internal configuration settings module 206 or load customized configuration setting module 204 can be configured to erase data pertaining to network appliance 200 that was collected during usage of customized configuration settings and then causing network appliance 200 to enter into internal configuration mode by loading internal settings and using appliance 200 based on loaded internal settings.

According to one embodiment, external customized configuration settings can be used for conducting a network audit on network appliance 200 based on the customized settings from external storage device. If, after conducting the network audit, it is found that it is desirable to replace certain default/internal settings of appliance 200 with specific external configuration settings, load internal configuration settings module 206 can be configured to store identified external configuration settings in internal memory and replace them with corresponding internal settings.

Run configuration setting module 208 is configured to run appliance 200 based on whether external configuration settings are loaded onto appliance 200. In case run configuration setting module 208 identifies that no external configuration settings are loaded on appliance 200, internal configuration settings 210 are automatically loaded from internal memory, else, external configuration settings are retrieved from RAM and used as and when desired to run appliance 200 under external configuration mode. As discussed above, considering network audit is the purpose for loading external customized configuration settings, the configuration settings can include parameters for auditing one or more of security, reliability, loopholes, quality of data, quality of service, and quality of transmission of network appliance 200.

In one embodiment, the functionality of one or more of the above-referenced functional units may be merged in various combinations. For example, load customized configuration settings module 204 and load internal configuration settings module 206 may be combined. Moreover, the various functional units can be communicatively coupled using any suitable communication method (e.g., message passing, parameter passing, and/or signals through one or more communication paths, etc.). Additionally, the functional units can be physically connected according to any suitable interconnection architecture (e.g., fully connected, hypercube, etc.).

According to embodiments of the invention, the functional units can be any suitable type of logic (e.g., digital logic, software code and the like) for executing the operations described herein. Any of the functional units used in conjunction with embodiments of the invention can include machine-readable media including instructions for performing operations described herein. Machine-readable media include any mechanism that provides (i.e., stores and/or transmits) information in a form readable by a machine (e.g., a computer). For example, a machine-readable medium includes read only memory (ROM), random access memory (RAM), magnetic disk storage media, optical storage media or flash memory devices.

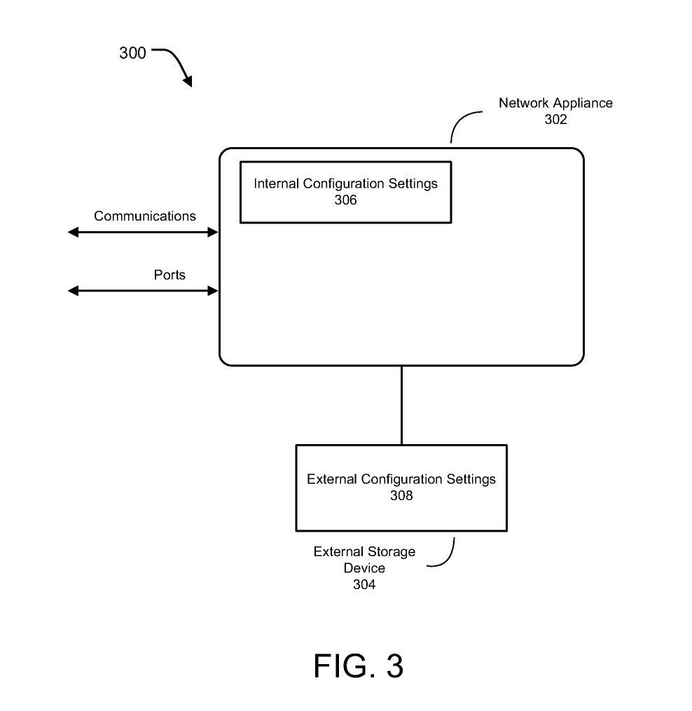

FIG. 3 illustrates a schematic diagram 300 showing connection between a network appliance 302 and an external storage device 304 storing customized configuration settings in accordance with an embodiment of the present invention. Network appliance 302 comprises one or more communication interfaces or ports (not shown) to accommodate external devices to be coupled to network appliance 302. Network appliance 302 is configured to store internal configuration settings 306 in its internal memory (not shown) and can be configured to run in a default mode based on the internal configuration settings 306, where the internal configuration settings 306 can be used to configure the manner in which traffic is to be handled, operated, routed, or monitored, among other operations by appliance 302.

When an external storage device 304 comprising customized configuration settings 308 in its respective memory is connected to network appliance 302 through a port or communication interface device to facilitate performance of a desired function, such as a network audit of network appliance 302 via one of ports, customized configuration settings 308 are loaded from external storage device 304 and used to configure network appliance 302 for auditing, for example. Notably, internal configuration settings 306 remain within the internal memory of network appliance 302 and thus remain available to be used to place the network appliance into its original state after the auditing or other functions to be performed in the external configuration mode are completed.

Upon completion of network auditing of network appliance 302, external storage device 304 is removed from port of network appliance 302 and RAM or other memory of appliance 302 containing data obtained during operation in accordance with customized configuration settings 308 is deleted or stored to external storage device 304, and internal configuration settings 304 stored in internal memory are loaded back for configuring network appliance 302 to run in default mode. In this manner, network appliance 302 is efficiently reverted back to its original state prior to the introduction of customized configuration settings 308.

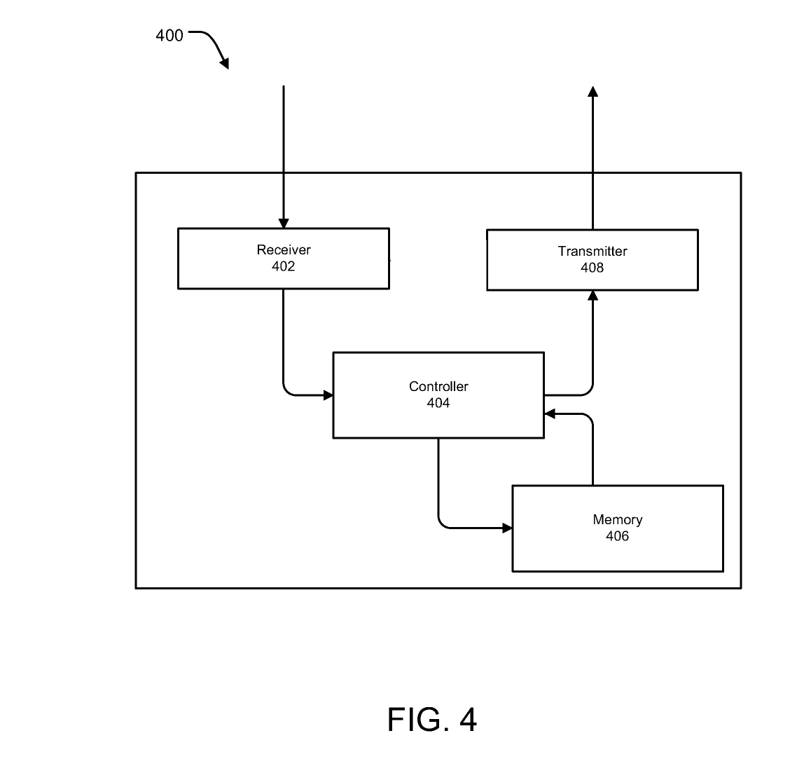

FIG. 4 illustrates exemplary structural components of an external storage device 400 in accordance with an embodiment of the present invention. As discussed above, external storage device 400 is configured to store, control, and transmit customized configuration settings in accordance with an embodiment of the present invention. Customized configuration settings, interchangeably also referred to as external configuration settings, can be amended by one or more network auditors or other stakeholders to enable a change in settings of network appliance to which device 400 is coupled.

External storage device 400 includes a receiver 402 for receiving customized configuration settings from a network auditor and also receiving data, content, instructions, or other communication from network appliance to which external storage device 400 is coupled via a communication interface or port of network appliance. External storage device 400 further includes a controller 404 that is configured to control the instructions received by receiver 402, transmitted by transmitter 408, and stored in memory 406. Apart from storing customized configuration settings, memory 406 of external storage device 400, can be configured to store any other appropriate content or parameter information that can be used for functioning of desired configuration changes on the network appliance to which device 400 is attached. Such stored content can include results or analysis of previous network audits such that the stored content can be compared at run time with currently generated network audit results, allowing a report indicating changes in audit results or performance of appliance to be generated.

Transmitter 408, apart from other functions, is configured to transmit external configuration settings from storage device 400 to network appliance and help load and run network appliance based on external configuration settings. Controller 404 manages receiving of data or instructions through receiver 402 and transmitting instructions or data through transmitter 408.

According to one embodiment, customized configuration setting parameters stored in memory 406 of external storage device 400 can include one or more valid traffic classes, a normal burst size, Weighted Fair Queuing (WFQ) bandwidth usage, a standby routing protocol, a router ID for Open Shortest Path First (OSPF) routing protocol, route reflector setup settings, Border Gateway Protocol (BGP) neighbour reachability information, a BGP synchronization setting, one or more multiprotocol label switching (MPLS) parameters, a log level, a community-string, an object qualifier and the like.

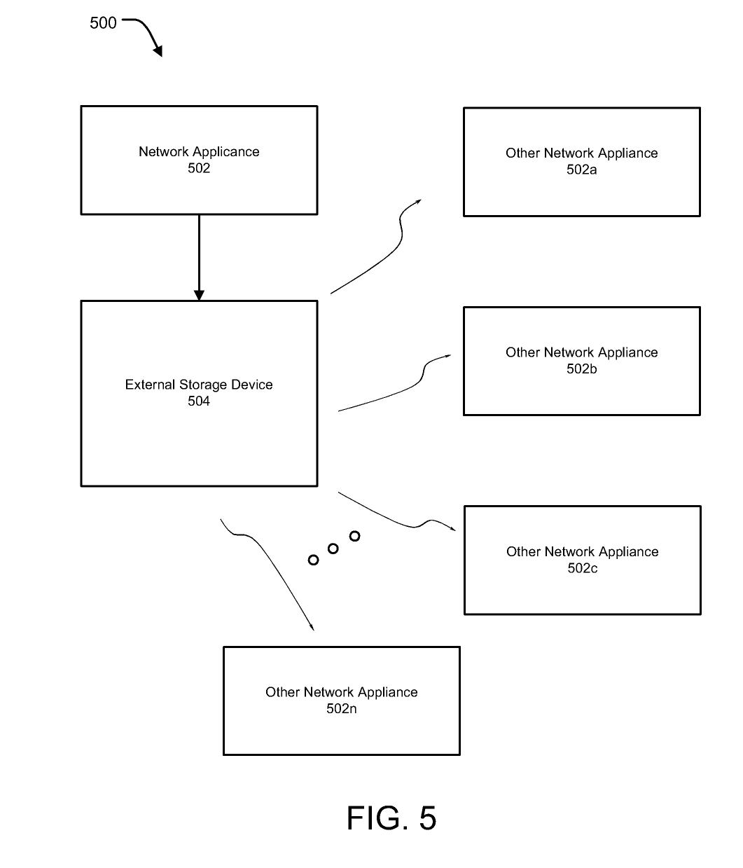

FIG. 5 illustrates use of an external storage device 504 for multiple network appliances 502 in accordance with an embodiment of the present invention. As illustrated, external storage device 504 is operable to be connected with and disconnected from multiple network appliances 502a, 502b, 502c . . . 502n, collectively referred to as network appliances 502 hereinafter. In operation, external storage device 504 can initially be connected with network appliance 502 for loading and running customized configuration settings on network appliance 502 to obtain information related to logging, data security, reliability, loopholes present in network appliance if any, quality of data both transmitted and received, quality of service provided to user, and quality of transmission of data.

External storage device 504 can then be connected to other network appliances 502a, 502bc 502c . . . and 502n present in a network. In an embodiment, external storage device 504 can either be connected to multiple network appliances 502 concurrently through multiple ports of external storage device 504 or can be connected to one appliance 502 at a time. Similarly, in another embodiment, each appliance 502 can be coupled with multiple external storage devices 504 such that customized configuration settings for different functions or even for a single function such as network audit can be selected from such devices 504. Customized configuration settings can be accessed by network appliances 502 from external storage device 504 either by a wired or a wireless connection such that network audits can be conducted in parallel across multiple network appliances 502.

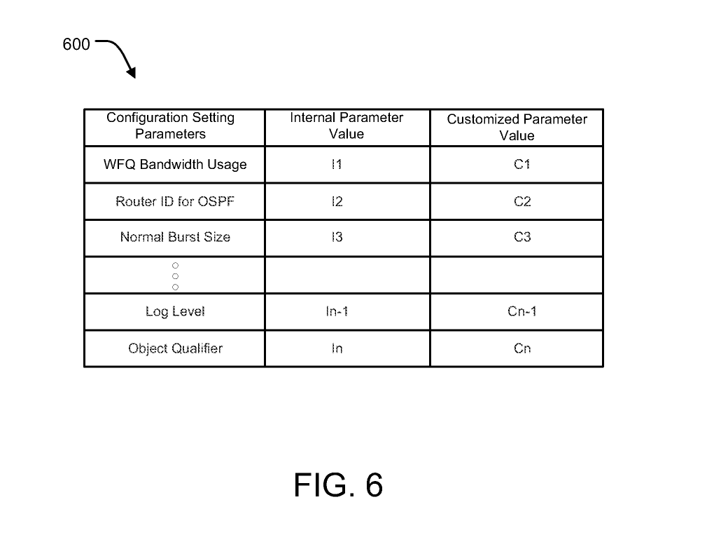

FIG. 6 illustrates a table 600 representing a set of parameters used for defining internal configuration settings and customized configuration settings along with their respective values. Those skilled in the art will appreciate that internal configuration settings may require many more parameters than stored by external storage device for customized configuration settings as external storage device can be made to store only such parameters that need to be used for conducting the specific function, such as network audit, verification, testing, among others on network appliance. However, the present disclosure would encompass all such cases in which the number of parameters in storage device is more than those stored in network appliance for defining internal configuration settings.

According to one embodiment, parameters of internal configuration settings and customized configuration settings that are monitored during network audit can include, but not limited to, valid traffic classes, a normal burst size, Weighted Fair Queuing (WFQ) bandwidth usage, a standby routing protocol, a router ID for Open Shortest Path First (OSPF) routing protocol, route reflector setup settings, Border Gateway Protocol (BGP) neighbour reachability information, a BGP synchronization setting, one or more multiprotocol label switching (MPLS) parameters, a log level, a community-string, an object qualifier, and such other parameters. Table 600 of FIG. 6 shows exemplary parameters WFQ bandwidth usage, Router ID for OSPF, normal burst size, log level and object qualifier and their values obtained from internal configurations and customized configurations.

During operation, when network appliance runs in a default mode (internal configuration mode), the network appliance is configured in accordance with values corresponding to internal configuration setting parameters (e.g., internal configuration settings 306). For instance, when in the internal configuration mode, parameter WFQ bandwidth usage would have its value set at I1, Router ID for OSPF would have its value set at I2, normal burst size would have its value set at I3, log level would have its value set at In−1, and object qualifier would have its value set at In. On the other hand, upon connecting an external storage device to network appliance, during the time the storage device is connected with network appliance, the network appliance is configured temporarily with externally provided customized configuration settings (e.g., external configuration settings 308) without affecting internal configuration settings. In such a case, customized configuration setting parameters values C1, C2, C3 . . . Cn−1 and Cn are obtained for parameters WFQ bandwidth usage, Router ID for OSPF, normal burst size, log level and object qualifier respectively and these values are configured for the network appliance. Once the external storage device is removed from network appliance, the network appliance is automatically configured again with internal configuration setting values without affecting operation of network appliance in any manner.

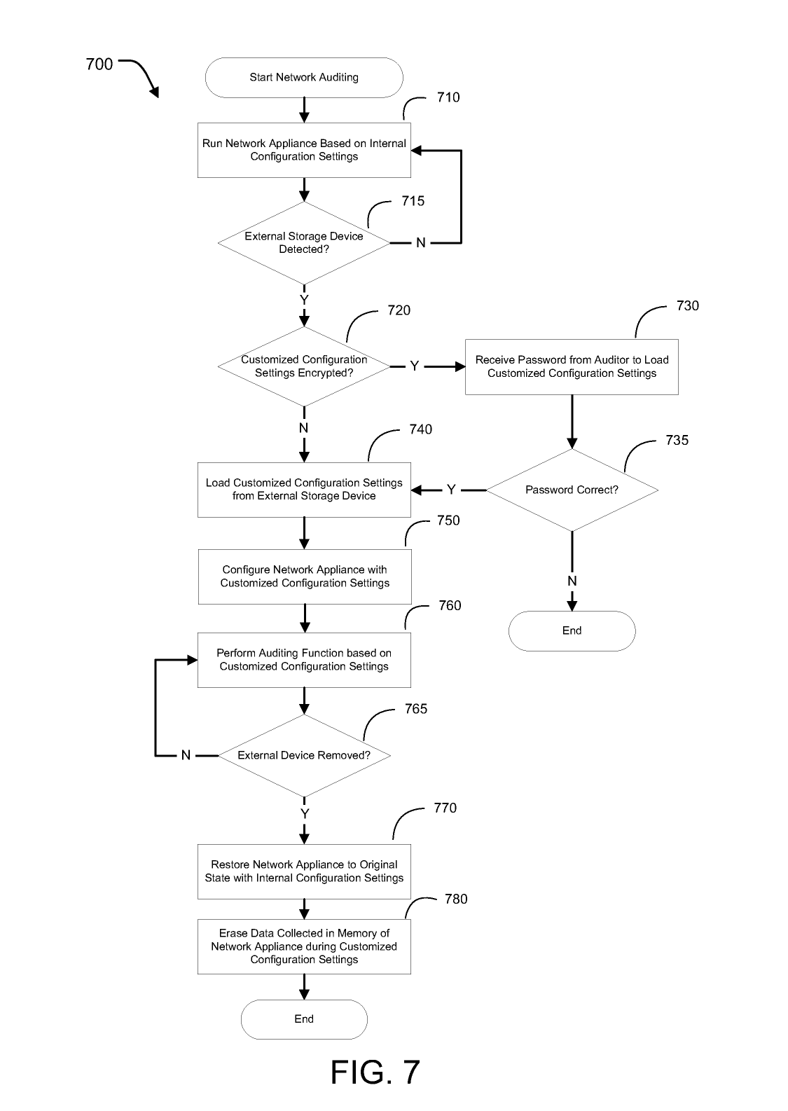

FIG. 7 is a flow diagram illustrating a method 700 for temporarily configuring a network appliance in accordance with externally provided customized configuration settings to facilitate one or more functions, such as auditing, verification, testing, among other such functions. In the present embodiment, customized configuration settings are present in an external storage device, which when connected to a network appliance changes the configuration mode of the network appliance to an external configuration mode such that once external storage device is decoupled, network appliance automatically reverts back to an internal configuration mode in which the network appliance is configured in accordance with internal configuration settings.

At block 710, internal configuration settings, which are internal to network appliance are used for configuring and enabling running of appliance to perform typical tasks related to network traffic management. Network appliance can include a router, hub, gateway, switch, personal computer, laptop, internet radio, web terminal, among other networking or computing devices. Internal configuration settings are default settings or settings set by operator of network appliance to enable efficient functioning of the appliance in the particular environment in which it is installed. Internal configuration settings are stored in internal memory of network appliance, which is associated with processor of the appliance and runs the appliance based on default internal configuration settings. Content or information generated during running of appliance based on internal configuration settings can be stored in internal memory and temporarily stored in RAM for easy access. Internal configuration settings can be defined by multiple parameters having specific values that are stored in internal memory and enable network appliance to run with those values for generating suitable and specific output. Configuration setting parameters can include one or more of valid traffic classes, a normal burst size, Weighted Fair Queuing (WFQ) bandwidth usage, a standby routing protocol, a router ID for Open Shortest Path First (OSPF) routing protocol, route reflector setup settings, Border Gateway Protocol (BGP) neighbour reachability information, a BGP synchronization setting, one or more multiprotocol label switching (MPLS) parameters, a log level, a community-string, an object qualifier, among other such parameters.

At block 715, network appliance is configured to check whether an external storage device has been coupled to the appliance and whether the detected storage device stores external customized configuration settings. External storage device can be coupled with network appliance through a communication interface device or a port of the appliance. If appliance does not detect connection of any external storage device via any interface device or port, the method returns back to block 710 and continues running the appliance based on internal configuration settings stored in its internal memory. If, on the other hand, network appliance detects an external storage device connected thereto, the method moves forward to block 720. External storage device can include Universal Serial Bus (USB) flash drive, a flash card, a Secure Digital (SD) card, an external hard drive, CD ROM, DVD ROM, and among other such non-volatile memory based devices.

At block 720, network appliance confirms whether customized configuration settings present in external storage device are encrypted. If customized configuration settings are encrypted, the method moves on to block 730, else to block 740.

At block 730, network appliance is configured to, based on encryption method used for encrypting customized configuration settings, prompt network auditor or administrator for password or private key and receive such password or key to move on to block 735 for password authentication.

At block 735, a password is matched with the stored password based on any known encryption-decryption algorithm and if the password is correct, the method moves on to block 740 for loading external customized configuration settings on network appliance. On the other hand, if the password entered by network auditor is incorrect, communication with external storage device can be terminated and appliance can continue to run based on default internal configuration settings.

At block 740, customized configuration settings from external storage memory are loaded on to network appliance for performing a specific administrative task, such as network auditing, for example. In one embodiment, the loading and use of customized configuration setting does not impact or change internal configuration settings in any manner. However, according to one embodiment, before loading customized configuration settings, content pertaining to internal configuration settings can be stored back in internal memory of appliance and removed from RAM of the appliance for allowing correct loading of customized configuration settings. Customized configuration settings can include one or more of valid traffic classes, a normal burst size, Weighted Fair Queuing (WFQ) bandwidth usage, a standby routing protocol, a router ID for Open Shortest Path First (OSPF) routing protocol, route reflector setup settings, Border Gateway Protocol (BGP) neighbour reachability information, a BGP synchronization setting, one or more multiprotocol label switching (MPLS) parameters, a log level, a community-string, an object qualifier, among any other parameter that is used for executing desired functionality on network appliance.

At block 750, once network appliance is loaded with customized configuration settings, the appliance is configured with the customized settings from external storage device. Once configured, the network appliance uses the settings and parameter values defined by customized configuration settings, allowing execution of network appliance under external configuration mode and use of appliance for desired functionality.

At block 760, auditing function is performed by network auditor on network appliance based on customized configuration settings present in external storage device. During the audit procedure, information or results generated as output can either be stored in internal memory or RAM of network appliance, or in memory of external storage device.

At block 765, network appliance checks for whether external storage device is removed from communication interface of network appliance. If external storage device is removed from communication interface of network appliance, process moves to block 770 for restoration and reconfiguration of network appliance with internal configuration settings. If external device has not been removed, the method returns back to block 760 and continues to execute appliance based on customized configuration settings.

At block 770, network appliance accesses internal memory and reconfigures itself based on default internal configuration settings stored therein. All parameter values can be automatically changed to default internal values and appliance starts running based on the internal configuration mode and can be configured to restore data generated from internal configuration settings on RAM for further use.

At block 780, network appliance erases data related to customized configuration settings of external storage device from internal memory or RAM of the appliance. Erasing data related to customized configuration settings helps in avoiding conflicts, undesired overwriting, cleaning memory space, and increasing speed of processing configuration settings.

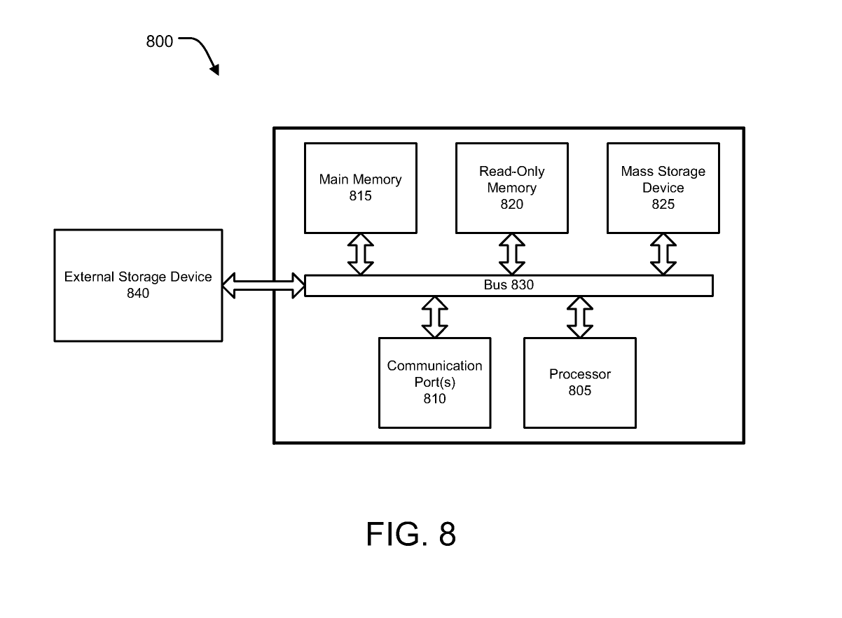

FIG. 8 is an example of a computer system 800 with which embodiments of the present disclosure may be utilized. Computer system 800 may represent or form a part of a network appliance (e.g., router/firewall 114 or switches 106a-b), a server or a client workstation.

Embodiments of the present disclosure include various steps, which will be described in more detail below. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware.

As shown, computer system 800 includes a bus 830, a processor 805, communication port 810, a main memory 815, a removable storage media 840, a read only memory 820 and a mass storage 825. A person skilled in the art will appreciate that computer system 800 may include more than one processor and communication ports.

Examples of processor 805 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 805 may include various modules associated with monitoring unit as described in FIG. 2. Processor 805 may include resource communication module 220 for establishing communication with resources coupled to the network. Processor 805 may further include policy module 225 for including various policies and scoring schemes. In addition, processor 805 may include reputation module 230 for generating reputation of the resources coupled to the network.

Communication port 810 can be any of an RS-232 port for use with a modem based dialup connection, a 10/100 Ethernet port, a Gigabit or 10 Gigabit port using copper or fiber, a serial port, a parallel port, or other existing or future ports. Communication port 810 may be chosen depending on a network, such a Local Area Network (LAN), Wide Area Network (WAN), or any network to which computer system 800 connects.

Memory 815 can be Random Access Memory (RAM), or any other dynamic storage device commonly known in the art. Read only memory 820 can be any static storage device(s) such as, but not limited to, a Programmable Read Only Memory (PROM) chips for storing static information such as start-up or BIOS instructions for processor 805.

Mass storage 825 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), such as those available from Seagate (e.g., the Seagate Barracuda 7200 family) or Hitachi (e.g., the Hitachi Deskstar 7K1000), one or more optical discs, Redundant Array of Independent Disks (RAID) storage, such as an array of disks (e.g., SATA arrays), available from various vendors including Dot Hill Systems Corp., LaCie, Nexsan Technologies, Inc. and Enhance Technology, Inc.

Bus 830 communicatively couples processor(s) 805 with the other memory, storage and communication blocks. Bus 830 can be, such as a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 805 to system memory.

Optionally, operator and administrative interfaces, such as a display, keyboard, and a cursor control device, may also be coupled to bus 830 to support direct operator interaction with computer system 800. Other operator and administrative interfaces can be provided through network connections connected through communication port 810.

Removable storage media 840 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

Components described above are meant only to exemplify various possibilities. In no way should the aforementioned exemplary computer system limit the scope of the present disclosure.

While embodiments of the present invention have been illustrated and described, it will be clear that the invention is not limited to these embodiments only. Numerous modifications, changes, variations, substitutions, and equivalents will be apparent to those skilled in the art, without departing from the spirit and scope of the invention, as described in the claim.

What is claimed is:

1. A method comprising:
providing a network appliance with a plurality of configuration modes, including an internal configuration mode and an external configuration mode;
when operating in the internal configuration mode, configuring the network appliance by loading and running configuration settings from a memory internal to the network appliance; and
when operating in the external configuration mode, configuring the network appliance by loading and running configuration settings from an external storage device coupled to an interface of the network appliance.

2. The method of claim 1, further comprising responsive to detecting the external storage device has been coupled to the interface, causing the network appliance to enter into the external configuration mode.

3. The method of claim 1, further comprising while in the external configuration mode performing audit processing including logging information relating to one or more of security, reliability, loopholes, quality of data, quality of service, and quality of transmission of the network appliance.

4. The method of claim 3, further comprising responsive to detecting the external storage device has been decoupled from the interface:
erasing from a memory of the network appliance data collected during the audit processing; and
causing the network appliance to enter into the internal configuration mode.

5. The method of claim 1, further comprising responsive to detecting the external storage device is not coupled to the interface, causing the network appliance to enter into the internal configuration mode.

6. The method of claim 3, wherein the configuration settings loaded from the external storage device are configured to facilitate auditing of one or more of security, reliability, loopholes, quality of data, quality of service, and quality of transmission of the network appliance.

7. The method of claim 6, wherein the configuration settings comprise one or more valid traffic classes, a normal burst size, Weighted Fair Queuuing (WFQ) bandwidth usage, a standby routing protocol, a router ID for Open Shortest Path First (OSPF) routing protocol, route reflector setup settings, Boader Gateway Protocol (BGP) neighbor reachability information, a BGP synchronization setting, one or more multiprotocol label switching (MPLS) parameters, a log level, a community-string and an object qualifier.

8. A method comprising:
detecting an external storage device coupled to an interface of a network appliance, wherein the network appliance is running in accordance with an original operating state as dictated by internal configuration settings stored in an internal memory of the network appliance;
responsive to the detecting:
loading customized configuration settings stored in the external storage device;
configuring the network applicance in accordance with the customized confuguration settings; and
performing a predetermined function based on the customized confuguration settings.

9. The method of claim 8, further comprising responsive to detecting decoupling of the external storage device from the interface:
restoring the network appliance to the original operating state; and
erasing from a memory of the network appliance data collected during the predetermined auditing function.

10. The method of claim 8, wherein the internal configuration settings comprises parameters configured to facilitate operation of the network appliance within an environment in which the network appliance is installed.

11. The method of claim 8, wherein the customized configuration settings comprise parameters configured to facilitate auditing of one or more of security, reliability, loopholes, quality of data, quality of service, and quality of transmission of the network appliance.

12. The method of claim 11, wherein the parameters comprise one or more valid traffic classes, a normal burst size, Weighted Fair Queuuing (WFQ) bandwidth usage, a standby routing protocol, a router ID for Open Shortest Path First (OSPF) routing protocol, route reflector setup settings, Boader Gateway Protocol (BGP) neighbor reachability information, a BGP synchronization setting, one or more multiprotocol label switching (MPLS) parameters, a log level, a community-string and an object qualifier.

13. The method of claim 8, wherein the network appliance comprises a network security system.

14. The method of claim 13, wherein the network appliance comprises a firewall or a unified threat management system.

15. The method of claim 8, further comprising, prior to configuring the network appliance in accordance with the customized configuration settings, decrypting the customized configuration settings.

16. A network appliance system comprising:
one or more processors;
a communication interface device;
one or more internal data storage devices operatively coupled to the one or more processors and storing:
internal configuration settings;
an external storage device detection module that, when executed by the one or more processors, indicates whether an external storage device is coupled to the communication interface device, wherein the external storage device stores customized configuration settings;
a load customized configuration settings module that, when executed by the one or more processors responsive to detecting the external storage device, loads system configuration settings from the customized configuration settings;
a load internal configuration settings module that, when executed by the one or more processors responsive to detecting an absence of the external storage device, loads system configuration settings from the internal configuration settings;
a run configuration settings module that, when executed by the one or more processors, configures the network appliance system in accordance with the loaded system configuration settings.

17. The system of claim 16, wherein the customized configuration settings comprises parameters configured to audit one or more of security, reliability, loopholes, quality of data, quality of service, and quality of transmission of the network appliance system.

18. The system of claim 16, wherein the customized configuration settings are encrypted.

19. The system of claim 16, wherein one or more of the internal configuration settings are used after the customized configuration settings are loaded.

20. The system of claim 16, wherein the external storage device comprises one of a Universal Serial Bus (USB) flash drive, a flash card, a Secure Digital (SD) card, and an external hard drive.

21. The system of claim 16, wherein the customized configuration settings or content related thereto are deleted from the network appliance system responsive to the external storage device being removed.

22. The system of claim 16, wherein the network appliance system comprises a firewall.

23. The system of claim 16, wherein the network appliance system comprises a unified threat management system.
